(19) United States
(12) Patent Application Publication
(10) Pub. No.: US 2026/0361142 A1
(43) Pub. Date: Nov. 12, 2026

(54) TRANSFORMER AND WIRELESS CHARGING DEVICE USING THE SAME

(71) Applicants: LITE-ON SINGAPORE PTE, LTD., Sigapore (SG); LITE-ON TECHNOLOGY CORPORATION, Taipei (TW)

(72) Inventors: Yijun PAN, Singapore (SG); Chee Khong Tiang, Singapore (SG); Yu-Wei CHIU, Taipei (TW)

(21) Appl. No.: 19/300,939

(22) Filed: Aug. 15, 2025

(30) Foreign Application Priority Data
May 9, 2025 (CN) 202510596183.6
Jun. 25, 2025 (CN) 202521311671.X

(51) Int. Cl. H02J 50/70; H01F 27/02; H01F 27/10; H01F 27/30; H02J 50/00; H02J 50/10

(52) U.S. Cl. CPC H02J 50/70; H01F 27/02; H01F 27/105; H01F 27/306; H02J 50/005; H02J 50/10

(57) ABSTRACT

A transformer includes a lower housing, a support frame, a supporting body, a plurality of magnetic conductive elements, and a coil. The lower housing has an inner sidewall that surrounds the inner surface of the lower housing. The supporting body and the support frame are interlocked and are disposed on the inner surface of the lower housing. The magnetic conductive elements are disposed between the support frame and the supporting body, and are arranged adjacent to each other. The bottom surfaces of the magnetic conductive elements are higher than or equal to the top surface of the inner sidewall. The coil is wound on the supporting body, and the coil and the magnetic conductive elements are located on opposite sides of the supporting body.

This application claims the benefits of People’s Republic of China application Serial No. 202510596183.6 filed May 9, 2025 and application Serial No.202521311671.X, filed Jun. 25, 2025, the subject matters of which are incorporated herein by reference.

### BACKGROUND OF THE INVENTION

### Field of the Invention

The invention relates in general to a power transmission system, and more particularly to a transformer and a wireless charging device using the transformer.

### Description of the Related Art

Wireless charging devices can be charged by electromagnetic induction, a primary coil is located in a charging station of a transmitter assembly and a secondary coil is located in a to-be-charged device of a receiver assembly. When a power is applied to the charging station, a current flows through the primary coil to create magnetic flux. When the secondary coil of the to-be-charged device is close to the primary coil, the magnetic flux is coupled to the secondary coil, thereby generating an induced current in the secondary coil. The induced current in the secondary coil charges the battery of the to-be-charged device.

However, whether it is the primary coil at the transmitting end or the secondary coil at the receiving end, the magnetic flux generated by the induced current is not uniform, inherently leading to some energy loss during the transfer and resulting in poor charging efficiency of the wireless charging device.

### SUMMARY OF THE INVENTION

The present invention relates to a transformer and a wireless charging device using the transformer to reduce magnetic leakage and improve charging performance.

According to one aspect of the present invention, a transformer is provided. The transformer includes a lower housing, a support frame, a supporting body, a plurality of magnetic conductive elements, and a coil. The lower housing has an inner sidewall that surrounds an inner surface of the lower housing. The supporting body and the support frame are interlocked and are disposed on the inner surface of the lower housing. The magnetic conductive elements are disposed between the support frame and the supporting body, and are arranged adjacent to each other. The top surfaces of the magnetic conductive elements are higher than or equal to the top surface of the inner sidewall. The coil is wound on the supporting body, and the coil and the magnetic conductive elements are located on opposite sides of the supporting body.

According to one aspect of the present invention, a wireless charging device is provided. The wireless charging device includes a power line and a transformer. The power line is used for power input. The transformer is connected to the power line to transmit a power. The transformer includes a lower housing, a support frame, a supporting body, a plurality of magnetic conductive elements and a coil. The lower housing has an inner sidewall, and the inner sidewall surrounds an inner surface of the lower housing. The supporting body and the support frame are interlocked with each other and arranged on the inner surface of the lower housing. The magnetic conductive elements are disposed between the support frame and the supporting body, and arranged adjacent to each other. The top surfaces of these magnetic conductive elements are higher than or equal to the top surface of the inner sidewall. The coil is wound on the supporting body, and the coil and the magnetic conductive elements are located on opposite sides of the supporting body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a circuit diagram of a wireless charging device according to an embodiment of the present invention.

FIG. 2A illustrates a perspective schematic diagram of a transformer according to an embodiment of the present invention.

FIGS. 2B and 2C illustrate exploded views of the transformer in FIG. 2A from different perspectives.

FIG. 3 illustrates a top view of the lower surface of an upper housing according to an embodiment of the present invention.

FIG. 4 illustrates a top view of the upper surface of a lower housing according to an embodiment of the present invention.

FIG. 5 illustrates a top view of a support frame and a supporting body interlocked and disposed above the lower housing according to an embodiment of the present invention.

FIG. 6 illustrates a cross-sectional view of a transformer at the buckle portion according to an embodiment of the present invention.

FIGS. 7 and 8 illustrate cross-sectional views of a transformer at the screw fastening portion according to an embodiment of the present invention.

FIG. 9 illustrates a schematic diagram of magnetic conductive elements and a support frame disposed on the lower housing.

### DETAILED DESCRIPTION OF THE INVENTION

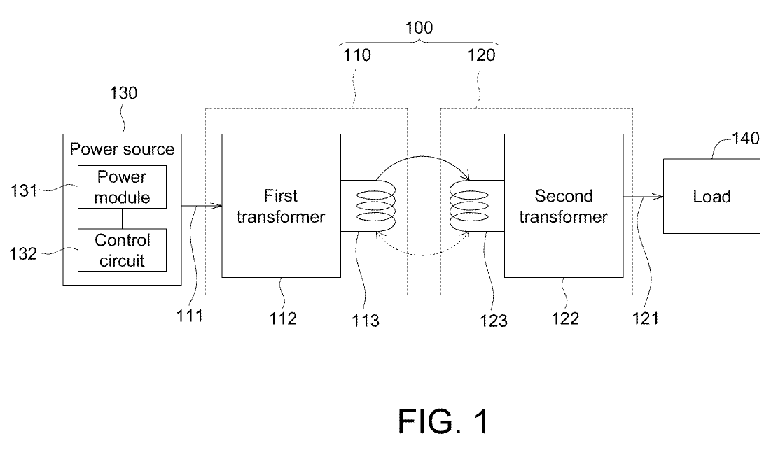

Referring to FIG. 1, a circuit diagram of a wireless charging device 100 is illustrated. The wireless charging device 100 includes a transmitter assembly 110 and a receiver assembly 120. The transmitter assembly 110 includes a first power line 111 and a first transformer 112. The receiver assembly 120 includes a second power line 121 and a second transformer 122. The transmitter assembly 110 is connected to a power source 130 via the first power line 111, and the receiver assembly 120 is connected to a load 140 (e.g., a battery of a device to be charged) via the second power line 121. When the power source 130 supplies a power to the transmitter assembly 110, the current passes through the primary coil 113 of the first transformer 112 to generate magnetic flux. When the secondary coil 123 of the second transformer 122 is positioned near the primary coil 113, the magnetic flux is coupled to the secondary coil 123, that is, the magnetic field generated by the primary coil 113 induces a voltage in the secondary coil 123, thereby generating an induced current in the secondary coil 123. Therefore, the induced current in the secondary coil 123 can charge the battery of the device to be charged. In other words, the wireless charging device 100 can achieve wireless transmission of electrical signals through near-field magnetic coupling.

The power source 130 may include a power module 131 and a control circuit 132. The control circuit 132 is used to control the voltage and current output by the power module 131. The first power line 111 is electrically connected to the power source 130 to provide a power input. The first transformer 112 is connected to the first power line 111, and the first transformer 112 can transmit a power to the second transformer 122 of the receiver assembly 120 through near-field magnetic coupling. The following is a description of the internal structure of the transformer. Since the internal structures of the first and second transformers 112 and 122 are similar, the following description is not limited to the first transformer 112 or the second transformer 122.

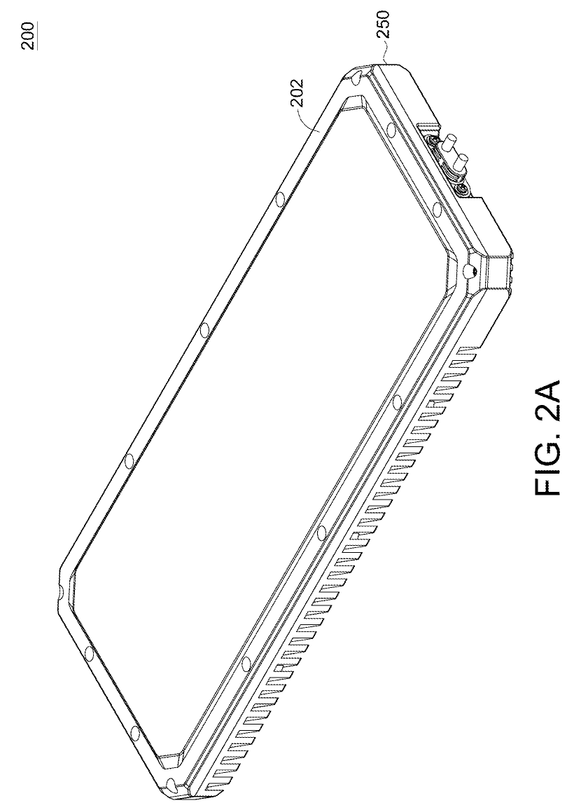

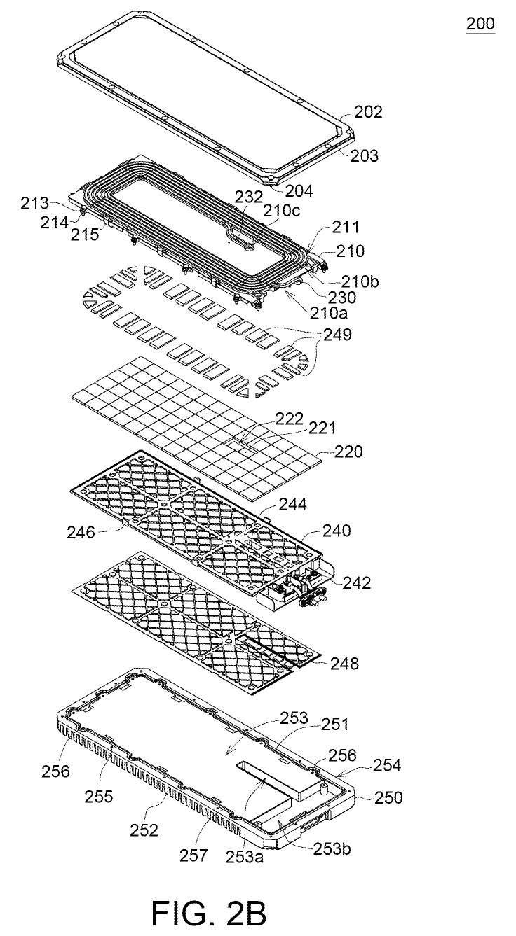

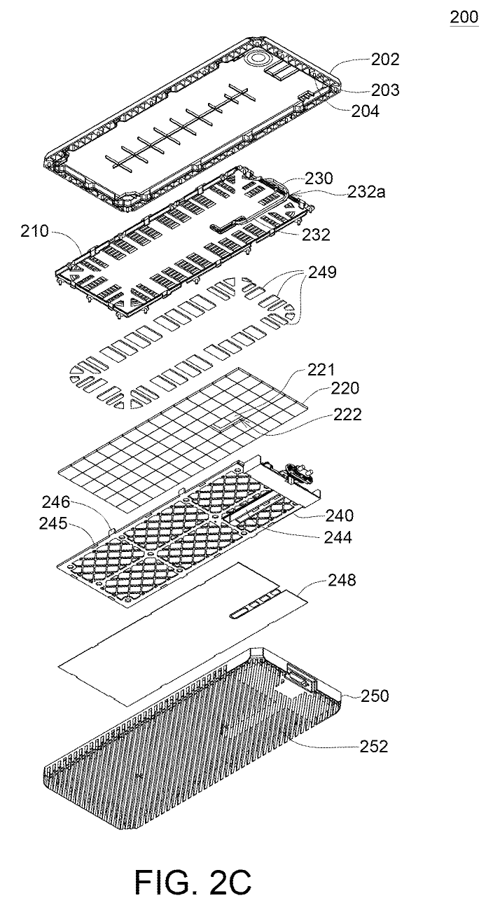

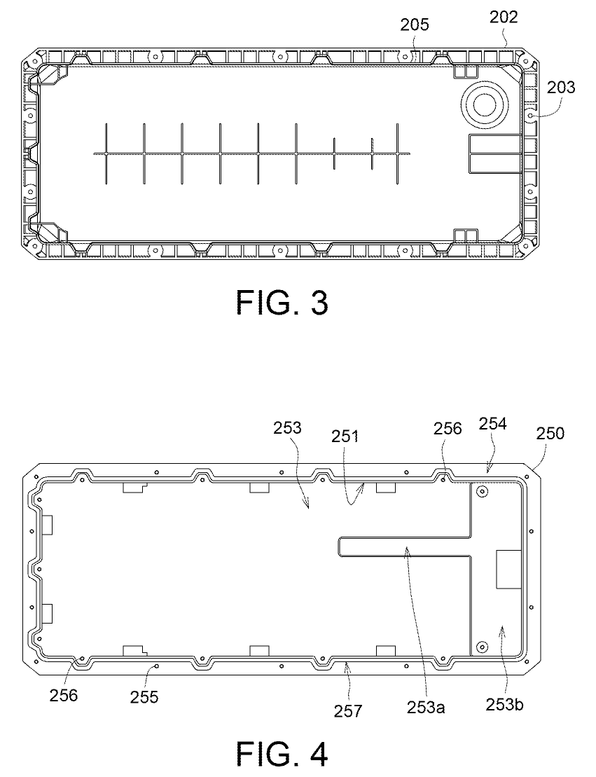

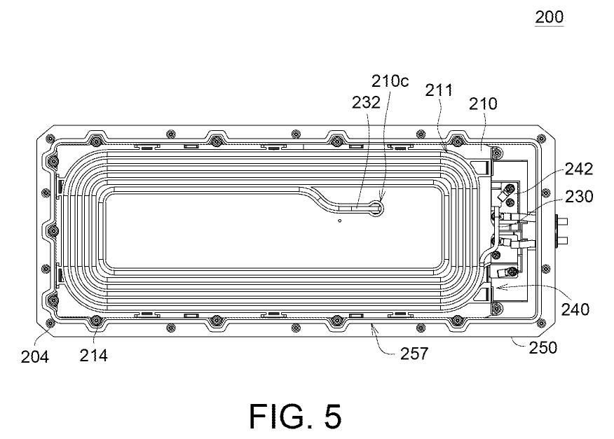

Referring to FIGS. 2A - 5, FIG. 2A illustrates a perspective schematic diagram of a transformer according to an embodiment of the present invention, and FIGS. 2B and 2C illustrate exploded views of the transformer 200 from different perspectives. FIG. 3 illustrates a top view of the lower surface of an upper housing 202 according to an embodiment of the present invention. FIG. 4 illustrates a top view of the upper surface of a lower housing 250 according to an embodiment of the present invention. FIG. 5 illustrates a top view of a support frame 240 and a supporting body 210 interlocked and disposed above the lower housing according to an embodiment of the present invention. The transformer 200 may be the first transformer 112 or the second transformer 122 mentioned above. The transformer 200 may be disposed in a ground/wall assembly and/or a vehicle assembly. The ground/wall assembly has a transmitter assembly, and the vehicle assembly has a receiver assembly. The ground/wall assembly and vehicle assembly can be wirelessly charged through near-field magnetic coupling. The vehicle assembly may include an automated guided vehicle (AGV) or an autonomous mobile robot (AMR).

In one embodiment, the transformer 200 includes an upper housing 202, a supporting body 210, a plurality of magnetic conductive elements 220, a coil 230 and a support frame 240. The lower housing 250 is a first housing, and the upper housing 202 is a second housing. The upper housing 202 can be a plastic housing, while the lower housing 250 can be a metal housing. The upper housing 202 and the lower housing 250 are disposed opposite each other to accommodate the supporting body 210, the magnetic conductive elements 220, the coil 230, and the support frame 240. The supporting body 210 may be a winding frame, and a winding groove 211 for accommodating the coil 230 is disposed on one side of the supporting body 210. As shown in FIG. 2B, the supporting body 210 has a first side 210a, a second side 210b, and at least one through hole 210c penetrating the first side 210a and the second side 210b, but the through hole 210c may not be required or may be replaced by other structures. The magnetic conductive elements 220 are disposed on the first side 210a of the supporting body 210, and the magnetic conductive elements 220 are arranged adjacent to each other. In addition, the coil 230 is wound on the second side 210b of the supporting body 210, that is, wound in the winding groove 211, and the coil 230 includes an internal threading wire 232 extending into the first side 210a of the supporting body 210 through the through hole 210c, as shown in FIGS. 2B, 2C and 5.

The magnetic conductive element 220 is a magnetic core, and may be made of a ferrite core. The magnetic conductive elements 220 are arranged in a grid or other shapes, for example. The magnetic conductive elements 220 are arranged in an array and adjacent to each other, and the size of the magnetic conductive element 220 is adjustable. For example, in order to allow the threading wire 232 to pass through the through hole 210c and enter the first side 210a of the supporting body 210, at least one of the magnetic conductive elements 220 forms a notch 222 at a position corresponding to the through hole 210c, and the notch 222 is used for the threading wire 232 to pass through. Therefore, the threading wire 232 can pass through the notch 222 of the magnetic conductive elements 220 in a downwardly inclined manner and enter the region below the notch 222.

In one embodiment, the threading wire 232 may be formed by multi-strand twisted wires or a flexible flat wire. The threading wire 232 may select the appropriate number of strands and wire diameter according to the current demand, and the multi-strand twisted wires have higher compliance when passing through the notch 222, thereby reducing loss and mechanical stress. In addition, multi-strand twisted wires may effectively reduce skin effect and proximity effect losses at high frequencies, thereby suitable for use under the operating frequency of wireless charging. Furthermore, smaller-size magnetic conductive elements 221 are provided around the threading wires 232 to prevent magnetic flux leakage and maintain a concentrated magnetic field, thereby preventing the notch 222 from being too large and causing magnetic flux divergence.

Referring to FIGS. 2B, 2C, and 5, the transformer 200 may include a wire outlet bracket 242, which is disposed on one side of the support bracket 240 and is used to fix an outlet terminal 232a of the threading wire 232. Therefore, the outlet end 232a of the threading wire 232 can be fixed to one side of the support frame 240 through the wire outlet bracket 242 to serve as a power input end or output end.

In addition, when the threading wire 232 enters the first side 210a of the supporting body 210, the threading wire 232 enters an elongated slot 244 of the support frame 240 and extends horizontally along the elongated slot 244. The lower housing 250 is disposed on the bottom surface of the support frame 240. That is, the support frame 240 is disposed between the lower housing 250 and the magnetic conductive elements 220. The outer surface of the housing 250 has a plurality of heat dissipation fins 252 to improve the heat dissipation efficiency of the transformer 200. In addition, the inner surface of the lower housing 250 has a deep groove 253a, whose position and extension direction correspond to the elongated slot 244, so that the threading wire 232 extending to the bottom of the support frame 240 can be fixed on the wire outlet bracket 242 through the deep groove 253a.

Referring to FIGS. 2B, 3, 4 and 7, the upper housing 202 is provided with a plurality of through-holes 203 on its peripheral surface, while the lower housing 250 is provided with a plurality of screw holes 255 on its peripheral surface (i.e., the outer annular surface 254) corresponding to the through-holes 203. A plurality of fasteners 204 (e.g., screws) can be individually inserted through the corresponding through-holes 203 and secured in the corresponding screw holes 255, and thereby the upper housing 202 to the lower housing 250 are connected to each other. Furthermore, to accommodate the support frame 240 and the thermal conductive medium 248, the lower housing 250 has an inner sidewall 251 defining a concave inner surface 253 and an outer annular surface 254. The inner sidewall 251 surrounds the inner surface 253 of the lower housing 250. The inner sidewall 251 is substantially perpendicularly connected between the concave inner surface 253 and the outer annular surface 254 and is a closed annular structure, and thereby a shallow recess on the inner surface of the lower housing 250 is formed. Therefore, the support frame 240 and the thermal conductive medium 248 can be disposed within the shallow recess.

In addition, the inner surface of the lower housing 250 also has another deep groove 253b for accommodating the wire outlet bracket 242, so that the wire outlet bracket 242 can be covered between the upper housing 202 and the lower housing 250.

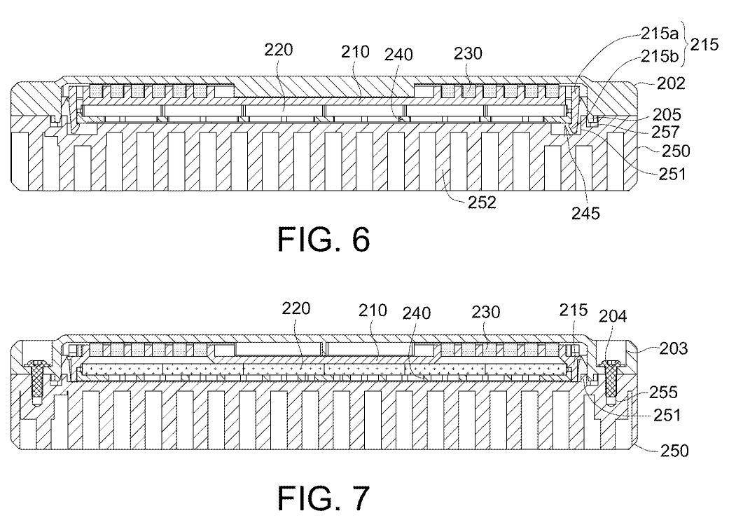

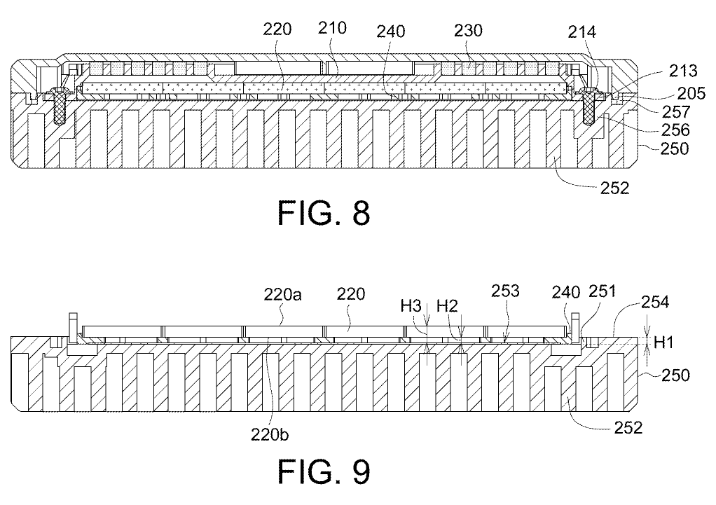

Referring to FIGS. 2B, 4, 5, and 8, a plurality of through-holes 213 are provided around the supporting body 210, and a plurality of screw holes 256 corresponding to the through-holes 203 are provided on the inner surface 253 of the lower housing 250 near the inner sidewall 251. A plurality of fasteners 214 (e.g., screws) can be individually passed through the corresponding through-holes 213 and fastened in the corresponding screw holes 256 to couple the supporting body 210 to the lower housing 250. Referring to FIGS. 5 and 6, in one embodiment, when the supporting body 210 is secured to the lower housing 250 via the fasteners 214, a separator ring 257 is provided to separate the inner sidewall 251 and the outer annular surface 254 of the lower housing 250 to improve waterproofing. Specifically, the separator ring 257 is located outside the inner sidewall 251 for preventing moisture from penetrating into the interior of the lower housing 250 via the outer annular surface 254.

Referring to FIGS. 3, 4, and 6, FIG. 6 illustrates a cross-sectional view of the transformer 200 in FIG. 5 at the buckle portion. The upper housing 202 may be provided with a rib 205 relative to the separator ring 257 of the lower housing 250. The rib 205 extends downward from the inner surface of the upper housing 202 to the separator ring 257 of the lower housing 250. The rib may not abut against the bottom surface of the separator ring 257 or may directly abut against the bottom surface of the separator ring 257. Since the rib 205 is a closed annular structure, the rib 205 and the separator ring 257 of the lower housing 250 form a closed water-blocking structure, similar to a waterproof ring, so that moisture cannot penetrate into the interior of the lower shell 250 through the outer ring surface 254. In addition, the interior of the separator ring 257 of the lower housing 250 may be filled with a sealing material (not shown), such as glue or a polymer, to enhance the overall waterproof performance of the transformer 200.

Referring to FIGS. 2B, 2C, and 6, a plurality of hooks 215 are provided around the supporting body 210 for engaging the support frame 240. A plurality of holes 245 are provided around the support frame 240 corresponding to the hooks 215, so that the supporting body 210 can be coupled to the support frame 240. The positions of the hooks 215 and the holes 245 are interchangeable, and their structures are not limited to those shown in this diagram. As shown in FIG. 6, the rod 215a of the hook 215 extends downward from the side of the supporting body 210 to the side of the support frame 240. The hook portion 215b of the hook 215 extends from the end of the rod 215a into the interior of the support frame 240 and is embedded in the hole 245, so that the hook 215 is interlocked with the hole 245. Furthermore, the supporting body 210 and support frame 240 can be aligned with each other using positioning members 246 disposed around the support frame 240. The assembled supporting body 210 and support frame 240 are then secured to the lower housing 250.

In one embodiment, in order to improve the heat dissipation performance of the transformer 200, before the supporting body 210 and support frame 240 are fixed to the lower housing 250, a thermal conductive medium 248 may be applied or filled onto the concave inner surface 253 defined by the inner sidewall 251. The thermal conductive medium 248 is, for example, a thermal interface material (TIM) to reduce the contact thermal resistance between the support frame 240 and the lower housing 250. The thermal conductive medium 248 may be a solid or semi-solid liquid, such as a heat dissipation pad or silicone grease containing an adhesive. The silicone grease is a viscous paste used to reduce the contact thermal resistance between the support frame 240 and the lower housing 250 to improve the heat dissipation performance.

In order to improve the heat dissipation performance of the transformer 200, before the supporting body 210 and support frame 240 are fixed to the lower housing 250, a thermal conductive medium 249 may be applied or filled between the magnetic conductive elements 220 and the supporting body 210. The thermally conductive medium 249 is, for example, a thermal interface material (TIM) that is used to reduce the contact thermal resistance between the supporting body 210 and the magnetic elements 220. The thermally conductive medium 249 may be a solid or semi-solid liquid, such as a heat dissipation pad or silicone grease containing an adhesive. The silicone grease is a viscous paste that is used to reduce the contact thermal resistance between the supporting body 210 and the magnetic elements 220 to improve heat dissipation performance.

Referring to FIG. 9, a schematic diagram of the magnetic conductive elements 220 and the support frame 240 disposed on the lower housing 250 is illustrated. The magnetic conductive elements 220 and the support frame 240 are disposed in a stacked manner on the concave inner surface 253 of the lower housing 250. Each of the magnetic conductive elements 220 has a top surface 220a and a bottom surface 220b. The top surfaces 220a of the magnetic conductive elements 220 are higher than the outer annular surface 254 of the lower housing 250, while the bottom surfaces 220b of the magnetic conductive elements 220 are higher than or equal to the outer annular surface 254 of the lower housing 250. Therefore, the height of the outer annular surface 254 and the inner sidewall 251 are substantially lower than the bottom surfaces 220b of the magnetic conductive elements 220, or the outer annular surface 254 and the bottom surfaces 220b of the magnetic conductive elements 220 are at the same height.

As shown in FIG. 9, the outer annular surface 254 (or inner sidewall 251) has a first height H1 relative to the concave inner surface 253 of the lower housing 250, while each of the bottom surfaces 220b of the magnetic conductive elements 220 has a second height H2 relative to the concave inner surface 253 of the lower housing 250. Furthermore, each of the top surfaces 220a of the magnetic conductive elements 220 has a third height H3 relative to the concave inner surface 253 of the lower housing 250. The third height H3 is greater than the second height H2, and the second height H2 is greater than or equal to the first height H1. Therefore, the magnetic flux of the magnetic conductive elements 220 is not blocked by the inner sidewall 251 of the lower housing 250, causing magnetic loss. Furthermore, due to the reduced heights of the outer annular surface 254 and the inner sidewall 251, the overall assembly thickness of the transformer 200 can be reduced to achieve a lightweight and thinner effect.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transformer, comprising:
a first housing having an inner sidewall surrounding an inner surface of the first housing;
a support frame;
a supporting body interlocked with the support frame and disposed on the inner surface of the first housing;
a plurality of magnetic conductive elements disposed between the support frame and the supporting body, the magnetic conductive elements being arranged adjacent to each other, wherein bottom surfaces of the magnetic conductive elements are higher than or equal to a top surface of the inner sidewall; and
a coil wound around one side of the supporting body, the coil and the magnetic conductive elements being located on opposite sides of the supporting body.

2. The transformer of claim 1, wherein the supporting body includes a through hole, and the coil includes a threading wire that enters a side of the supporting body opposite to the support frame from the through hole.

3. The transformer of claim 2, wherein at least one of the magnetic conductive elements has a notch formed at a position corresponding to the through hole.

4. The transformer of claim 2, further comprising a wire outlet bracket disposed on a side of the support frame, wherein one end of the threading wire passes through the through hole and is fixed to the wire outlet bracket.

5. The transformer of claim 1, wherein the supporting body is a winding frame, and a winding groove is provided on a side of the supporting body for accommodating the coil.

6. The transformer of claim 1, wherein the inner sidewall defines a concave inner surface and an outer annular surface, the inner sidewall being vertically disposed between the concave inner surface and the outer annular surface, and the inner sidewall is a closed annular structure.

7. The transformer of claim 6, wherein the supporting body is provided with a plurality of through-holes, and the concave surface is provided with a plurality of screw holes corresponding to the through-holes near the inner sidewall.

8. The transformer of claim 7, further comprising a plurality of fasteners, the fasteners passing through the corresponding through-holes and being secured in the corresponding screw holes, respectively.

9. The transformer of claim 1, wherein the support frame is provided with a plurality of positioning members, and the supporting body and the support frame are aligned with each other via the positioning members.

10. The transformer of claim 6, wherein the inner sidewall of the first housing is separated from the outer annular surface by a separator ring.

11. The transformer of claim 10, further comprising a second housing, the second housing being disposed opposite to the first housing, and the second housing having a rib relative to the separator ring, the rib extending from the second housing to the separator ring, and the rib being a closed annular structure.

12. The transformer of claim 6, wherein the outer annular surface has a first height relative to the concave inner surface, the bottom surfaces of the magnetic conductive elements have a second height relative to the concave inner surface, and top surfaces of the magnetic conductive elements have a third height relative to the concave inner surface, wherein the third height is greater than the second height, and the second height is greater than or equal to the first height.

13. The transformer of claim 1, wherein the supporting body is provided with a plurality of hooks for engaging the support frame, and the support frame is provided with a plurality of holes corresponding to the hooks.

14. The transformer of claim 1, further comprising a thermally conductive medium disposed between the support frame and the first housing.

15. The transformer of claim 1, further comprising a thermally conductive medium disposed between the supporting body and the magnetic conductive elements.

16. A wireless charging device comprising:
a power line for power input; and
a transformer connected to the power line to transmit a power, the transformer comprising:
a first housing having an inner sidewall surrounding an inner surface of the first housing;
a support frame;
a supporting body interlocked with the support frame and disposed on the inner surface of the first housing;
a plurality of magnetic conductive elements disposed between the support frame and the supporting body, the magnetic conductive elements being arranged adjacent to each other, wherein bottom surfaces of the magnetic conductive elements are higher than a top surface of the inner sidewall; and
a coil wound around one side of the supporting body, the coil and the magnetic conductive elements being located on opposite sides of the supporting body.

17. The wireless charging device of claim 16, wherein the supporting body includes a through hole, and the coil includes a threading wire that enters a side of the supporting body opposite to the support frame from the through hole.

18. The wireless charging device of claim 17, wherein at least one of the magnetic conductive elements has a notch formed at a position corresponding to the through hole.

19. The wireless charging device of claim 17, further comprising a wire outlet bracket disposed on a side of the support frame, wherein one end of the threading wire passes through the through hole and is fixed to the wire outlet bracket.

20. The wireless charging device of claim 16, wherein the supporting body is a winding frame, and a winding groove is provided on a side of the supporting body for accommodating the coil.

21. The wireless charging device of claim 16, wherein the inner sidewall defines a concave inner surface and an outer annular surface, the inner sidewall being vertically disposed between the concave inner surface and the outer annular surface, and the inner sidewall is a closed annular structure.

22. The wireless charging device of claim 21, wherein the supporting body is provided with a plurality of through-holes, and the concave surface is provided with a plurality of screw holes corresponding to the through-holes near the inner sidewall.

23. The wireless charging device of claim 22, further comprising a plurality of fasteners, the fasteners passing through the corresponding through-holes and being secured in the corresponding screw holes, respectively.

24. The wireless charging device of claim 16, wherein the support frame is provided with a plurality of positioning members, and the supporting body and the support frame are aligned with each other via the positioning members.

25. The wireless charging device of claim 21, wherein the inner sidewall of the first housing is separated from the outer annular surface by a separator ring.

26. The wireless charging device of claim 25, further comprising a second housing, the second housing being disposed opposite to the first housing, and the second housing having a rib relative to the separator ring, the rib extending from the second housing to the separator ring, and the rib being a closed annular structure.

27. The wireless charging device of claim 21, wherein the outer annular surface has a first height relative to the concave inner surface, the bottom surfaces of the magnetic conductive elements have a second height relative to the concave inner surface, and top surfaces of the magnetic conductive elements have a third height relative to the concave inner surface, wherein the third height is greater than the second height, and the second height is greater than or equal to the first height.

28. The wireless charging device of claim 16, wherein the supporting body is provided with a plurality of hooks for engaging the support frame, and the support frame is provided with a plurality of holes corresponding to the hooks.

29. The wireless charging device of claim 16, further comprising a thermally conductive medium disposed between the support frame and the first housing.

30. The wireless charging device of claim 16, further comprising a thermally conductive medium disposed between the supporting body and the magnetic conductive elements.
